(19) United States
(12) Patent Application Publication
(10) Pub. No.: US 2025/0025722 A1
(43) Pub. Date: Jan. 23, 2025

(54) MULTIPURPOSE SLIDING APPARATUS

(71) Applicant: HANKOOK RAIL SYSTEM CO., LTD., Gimpo-si (KR)

(72) Inventor: Hoseop YOON, Seoul (KR)

(21) Appl. No.: 18/614,968

(22) Filed: Mar. 25, 2024

(30) Foreign Application Priority Data
Jul. 17, 2023 (KR) 10-2023-0092266

(51) Int. Cl. A62B 35/00

(52) U.S. Cl. CPC A62B 35/0068; A62B 35/005

(57) ABSTRACT

The present invention relates to a multipurpose sliding apparatus, and more specifically, to a multipurpose sliding apparatus connected with a safety strap that ensures safe movement of a worker at a high place, in which one of the two fixing parts detachably coupled in different directions is fixedly coupled to a support object such as a scaffold at a construction site, the other fixing part comprises a fixing member coupled with the mounting member, which is a fixing object on which a roller part of a sliding member connected with a safety strap slides, and each fixing part of such fixing members comprises a fixing means for maintaining a gripping coupling of tongs that detachably couples an object to a recessed seating groove of a tongs housing, and at the same time, comprises a fixing means for fixing the coupling position.

### TECHNICAL FIELD

The present invention relates to a multipurpose sliding apparatus, and more specifically, to a multipurpose sliding apparatus connected with a safety strap that ensures safe movement of a worker at a high place, in which one of the two fixing parts detachably coupled in different directions is fixedly coupled to a support object such as a scaffold at a construction site, the other fixing part comprises a fixing member coupled with the mounting member, which is a fixing object on which a roller part of a sliding member connected with a safety strap slides, and each fixing part of such fixing members comprises a fixing means for maintaining a gripping coupling of tongs that detachably couples an object to a recessed seating groove of a tongs housing, and at the same time, comprises a fixing means for fixing the coupling position.

### BACKGROUND ART

According to the Ministry of Employment and Labor's supplementary statistics on the status of industrial accidents, “Current status of accidents and fatalities deaths subject to disaster investigation in 2022”, of the 644 fatal accidents that occurred in 2022, 388 people died from a fall, accounting for 60% of all fatal accidents.

Safety devices for preventing such a fall have already been proposed, and their use is also mandated.

In one example, Korean Patent No. 10-1208817 registered on Nov. 29, 2012 entitled “Multipurpose guide holder” suggests a multipurpose guide holder comprising: a guide tube in which a part of thereof is opened in a longitudinal direction; a roller member in which a head unit is combined with the inside of the guide tube; a guide hole formed inside the guide tube.

In the above prior art, not only a support base must be additionally provided in order to install the guide tube on which the roller member slides, but also the roller member, which is seated inside the guide tube and is partially exposed to the outside so that the safety strap can be connected, should have a structure that can slide inside the guide tube unless continuous guide tubes are connected and installed. Accordingly, there is a disadvantage that the guide tubes must be continuously connected and installed without interruption over the entire section.

In addition, Korean Patent No. 10-2055377 registered on Dec. 6, 2019 entitled “Safety hook for fall prevention” discloses a safety hook for fall prevention comprising: a circular ring body in which openings with a predetermined length are formed in a circumferential direction; and one pair of opening/closing fingers formed for elastic insertion and protrusion at both ends of the ring body and adjusting a width of the openings so that the ring body is coupled to or separated from a scaffold.

In the above prior art, when the ring body moves along the horizontal pipe of the scaffold, the opening/closing fingers installed on both ends of the opening of the ring body are configured to operate elastically in the vertical tube part of the scaffold and pass through while adjusting the width of the opening. This is a concept that operates on the premise that all horizontal pipes of the scaffold are placed inside the worker, and all vertical pipes are installed outside the worker, which is disadvantageous in that its scope of application is limited. In addition, the opening/closing finger of the above prior art is configured to elastically control the opening width of the ring body when coming into contact with the scaffold pipe. When a concentrated load occurs, such as a fall of a worker, the opening/closing fingers come into contact with the scaffold pipe. In this case, the opening/closing fingers may perform an opening operation while coming in contact with the scaffold pipe, thereby raising doubts about the fall prevention effect.

### PRIOR ART LITERATURE

### Patent Literature

(Patent Literature 1) Korean Patent No. 10-1208817 (registered on Nov. 29, 2012)
(Patent Literature 2) Korean Patent No. 10-2055377 (registered on Dec. 6, 2012)
(Patent Literature 3) Korean Patent No. 10-2450385 (registered on Sep. 28, 2012)
(Patent Literature 4) Korean Unexamined Patent Publication No. 10-2023-0033308 (published on Mar. 8, 2023)

### DETAILED DESCRIPTION OF THE INVENTION

### Technical Problem

An object of the present invention is to suggest a configuration that not only takes into account the advantages and disadvantages of the above conventional methods and prior arts and adopts the most effective method, but also is different from a configuration of the prior art while having a more economical and concise structure, thereby providing a multipurpose sliding apparatus that enriches a technical diversity.

Another object of the present invention is to provide a multipurpose sliding apparatus having a simple configuration that allows the installation of a sliding apparatus without a separate attachment device along the working route of high lift work, especially along the entire working route of the system scaffold, and ensures convenience in installation and disassembly as well as economic efficiency.

Another object of the present invention is to provide a multipurpose sliding apparatus that can stably maintain a coupling position even when an external force is generated by the fixing member that fixes the sliding apparatus to an object.

Yet another object of the present invention is to provide a multipurpose sliding apparatus that enables constant and stable sliding by preventing a sliding member, which moves slidably along a mounting member and/or a connecting member from rotating with respect to the mounting member and/or the connecting member.

### Technical Solution

In order to achieve the above-mentioned object, according to the present invention, there is provided a multipurpose sliding apparatus comprising: a fixing member in which two fixing parts each having a tongs that detachably seat and couple an object to the recessed seating groove of the tongs housing are coupled in different directions, and which comprises a fixing means that maintains the coupling state of the object by the tongs and at the same time fixes the coupling position; a mounting member in which a fixed head part integrally equipped with a guide tube part is fixedly coupled to one of the fixing parts; and a sliding member provided with a roller part that slides along the guide tube part.

Preferably, the tongs housing is formed with an opposing through hole that passes in a straight line through a pair of opposing side walls in which the recessed seating groove is provided at the end extending in the vertical direction from the support plate; and a pair of claws axially opposing the shaft rod installed on the opposing side wall are installed so as to operate elastically by a torsion spring, whereby in the tongs, which couples and fixes an object by entering and seating it into the recessed seating groove, a claw through hole is formed through a pair of tongs claws, and during the gripping operation of the tongs on an object, the rod-shaped fixing means that crosses the opposing through hole and the craw through hole arranged in a straight line are inserted and coupled to each other, so that the position between the fixing part and the object is fixed.

Preferably, the mounting members are coupled to the fixing member and arranged spaced apart from each other, and the mounting members arranged spaced apart from each other are connected by a connecting member provided with a connecting tube part that connects at least the guide tube parts to each other.

Preferably, the mounting member comprises a configuration in which the fixing head part is hooked and fixed to the fixing part using protruding heads that protrude on both sides along the longitudinal direction, and the roller part slides in the longitudinal direction of the outer circumferential surface of the guide tube part, which is connected to the fixed head part with the mounting connection part, and at the same time, the connecting tube part of the connection member is coupled to the connection sockets provided at both ends of the guide tube part in the longitudinal direction.

Preferably, the guide tube part and the connecting tube part are formed as circular pipes corresponding to each other, and the roller unit slides along the longitudinal direction of the outer circumferential surface of the circular pipe, wherein a part of the outer circumferential surface of the circular pipe is a flat surface along the longitudinal direction and is formed into a guide surface and a connection surface, respectively, so that the roller part sliding on the guide surface and the connecting surface is prevented from rotating in the circumferential direction.

### Advantageous Effects

The multipurpose sliding apparatus of the present invention having the configuration as above has a simple and simple configuration in which a sliding member connected to a safety strap slides along a mounting member that is fixedly mounted to a fixing member capable of connecting and coupling in multiple directions, or a sliding member slides along a mounting member and a connecting member connecting the mounting member, thereby having the advantage of being economical and easy to install and dismantle.

In addition, since the fixing member of the present invention is configured such that two fixing parts that detachably fix and couple an object are coupled facing different directions from each other, it has the advantage of being able to connect and configure different objects from each other even if they are vertically or horizontally related.

Moreover, since the fixing member of the present invention has two fixing parts for fixing the object, and the individual fixing part is provided with a fixing means capable of fixing the clamping force of the tongs that grips and fixes the object, there is an advantage that the fixing and coupling force of the fixing member to the object is always maintained constant even if an external force is generated.

Further, since the mounting member and/or the connecting member on which the sliding member of the present invention slides is formed as a flat surface on one side of the outer circumferential surface along the longitudinal direction, this flat surface has the advantage of preventing the sliding member from rotating in the circumferential direction and ensuring stable sliding.

(*The cutting surface above is not a machined surface, but a surface that has been formed flat by a mold from the time of initial production.)

### BRIEF DESCRIPTION OF THE DRAWINGS

FIG. 1 is a perspective view of a system scaffold on which the sliding device of the present invention is installed.

FIG. 2 is a perspective view of the sliding apparatus of the present invention.

FIG. 3 is an exploded perspective view of the fixing member of the present invention.

FIG. 4 is a side view of FIG. 2.

FIG. 5 is an illustrative diagram showing another embodiment of the guide tube part in a configuration connected to the fixed head part, the guide tube part, and the mounting connection part in the mounting member of the present invention.

### DETAILED DESCRIPTION OF THE EMBODIMENTS

Hereinafter, the present invention will be described in detail using the accompanying drawings. However, since the attached drawings show preferred embodiments of the present invention, the scope of the rights of the present invention is not limited by these drawings. In addition, even if the configuration is essentially required for carrying out the present invention, specific explanations of configurations that belong to known techniques or that can be easily implemented by a person skilled in the art from known techniques will be omitted.

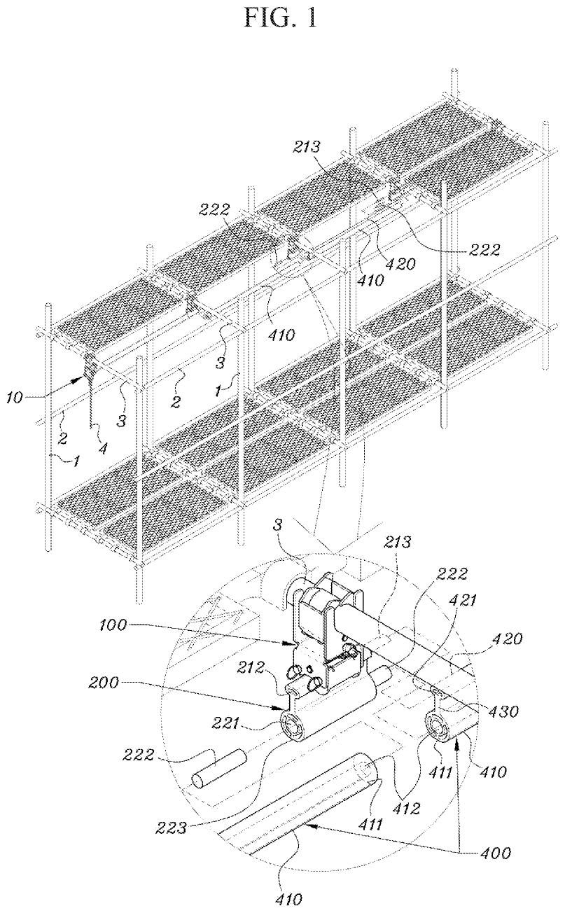

The multipurpose sliding apparatus 10 of the present invention is intended to prevent a worker from falling during work at heights, and is mainly used in the system scaffold at construction sites, as shown in FIG. 1. The present invention will be described on the premise that the sliding apparatus 10 is installed and used on a system scaffold. However, the sliding apparatus 10 of the present invention can be used in various applications, such as greenhouses, hoists, and work lines for building management, in addition to the system scaffold.

As shown in FIGS. 1 to 4, the multipurpose sliding apparatus 10 of the present invention includes a fixing member (100) provided with a fixing means 120 in two fixing parts (110) for fixing an object in different directions, a mounting member 200 in which a fixing head part 210 integrally equipped with a guide tube part 220 is coupled to one of the fixing parts (110), and a sliding member 300 that slides along the guide tube part 220.

A plurality of the fixing members 100 are installed along the work route, and the plurality of fixing members 100 can be continuously installed in a linear fashion using only the mounting member 200 without a connecting member 400. However, preferably, as shown in FIG. 1, one mounting member 200 is coupled to one fixing member (100), and another mounting member 200 adjacent to one mounting member 200 is connected to the connecting member 400.

As shown in FIG. 1, the fixing member (100) can be installed on a joist pipe 3 on which the work platform is installed in the system scaffold where the vertical pipe 1 and the horizontal pipe 2 are connected. However, the fixing member is not limited thereto, and not only it can be fixedly installed on the vertical pipe 1 or the horizontal pipe 2, but also it can be installed even if each pipe is in a vertical or horizontal relationship with each other. The reason why the fixing member (100) can be installed in in various positions is because two fixing parts (110) are provided on the fixing member (100) so as to be removably attached to the fixing member (100) in different directions. In addition, the scaffold including the joist pipe 3, the vertical pipe 1 and the horizontal pipe 2 coupled to the fixing part 110 is fixedly coupled to each fixing part 110 by a fixing means 120 and, at the same time, the coupling position is fixed.

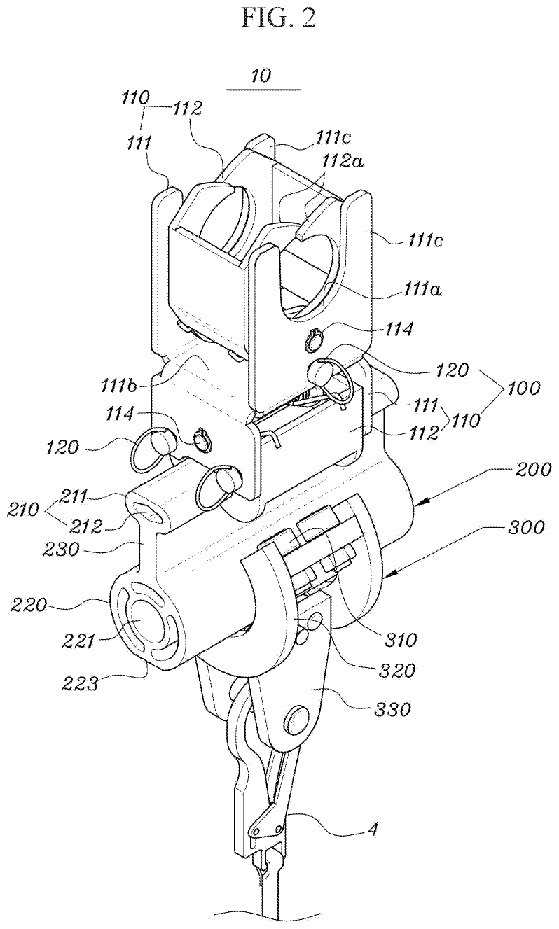

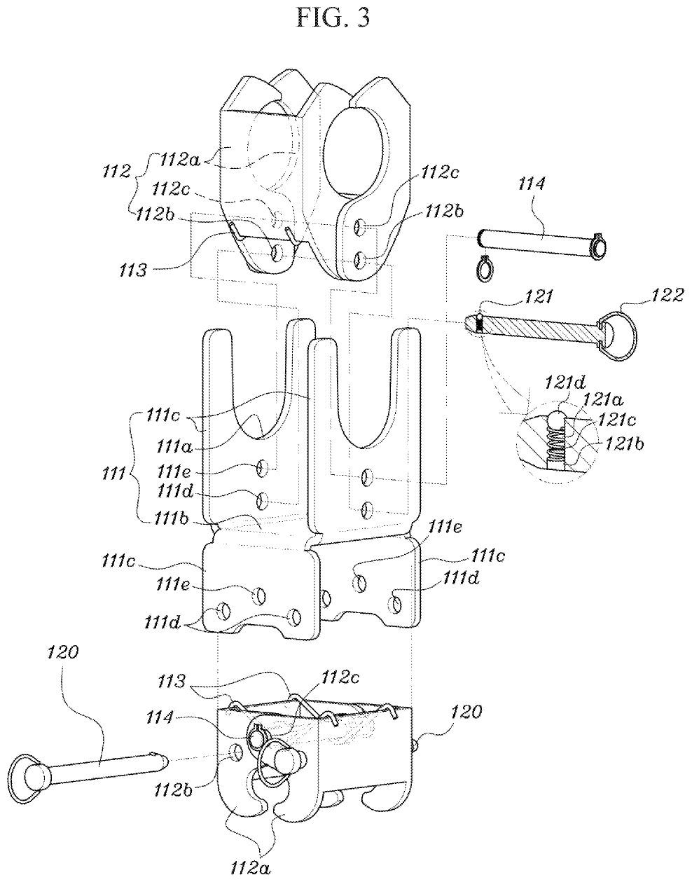

Referring to FIGS. 2 and 3, the individual fixing part 110 is configured to include tongs 112 that fixedly couple the object inserted into the tongs housing 111, which is provided with a recessed seating groove (111a) into which the object is inserted and seated.

As shown in FIG. 2, in the two fixing parts (110) which are detachably coupled in different directions, the horizontal sides of one support plate 111b having a square shape may form a pair with each other and form two pairs of opposing side walls 111c that are bent and extended vertically. Each pair of opposing side walls 111c may be formed in opposite directions. Unlike the same, the two pairs of opposing side walls 111c formed in opposite directions to each other may be provided on different support plates 111b, and then the support plates 111b may be coupled together. A groove-shaped recessed seating groove (111a) is formed at the extended end of the opposing side wall 111c formed as described above.

Further, the side walls 111c forming a pair may be formed with a shaft through hole 111e and an opposing through hole 111d that penetrate through the individual opposing side walls 111c on both sides in a straight line.

A shaft rod 114 is installed in the shaft through hole 111e. The shaft rod 114 is provided with the tongs 112, which are a pair of craws 112a that are configured to face each other so as to rotate about a shaft hole 112c correspondingly coupled to the shaft rod 114, so that the object inserted into the recessed seating groove (111a) is seated and fixed. Herein, the pair of claws 112a have their centers fitted into the shaft rod 114, and the tongs 112 may be installed to operate elastically as a whole by means of a torsion spring 113 at both ends of which are hooked and fixed to the ends of a pair of claws 112a.

Further, a pair of claws 112a constituting the tongs 112 may be formed by penetrating through a claw through hole 112b. The claw through hole 112b and the opposing through hole 111d formed through the opposing side wall 111c are configured for installing the fixing means 120.

In other words, when an object comes into contact with the end of the recessed seating groove (111a) and then pushed in, a pair of claws 112a that had closed the entrance of the recessed seating groove (111a) are expanded around the shaft rod 114 by the elastic action of the torsion spring 113, so that the object enters the recessed seating groove (111a) and is seated. At the same time as the seating of the object is completed, the pair of claws 112a close the entrance of the recessed seating groove (111a) through a retracting clamping action due to the contracting action of the torsion spring 113, thereby fixedly coupling the object onto the recessed seating groove (111a).

On the other hand, when the gripping operation of the tongs 112, which is a pair of craws 112a, is completed, the opposing through hole 111d and the claw through hole 112b are arranged in a straight line. The rod-shaped fixing means 120 crossing them is inserted and coupled to the opposing through hole 111d and the claw through hole 112b, which are placed in a straight line in this manner. The tongs housing 111 and the tongs 112 are integrated by the fixing means 120 inserted into the opposing through hole 111d and the craw through hole 112b, thereby stably and firmly fixing and supporting the object. Through this, even if an external force occurs on the object and/or the sliding apparatus 10, the object fixed to the fixing part 110 can maintain a constant coupling state without fear of separation, and at the same time, there is an advantage that the coupling position of the object and the fixing member (100) is also stably maintained and fixed.

In the above, the fixing means 120 has a rod shape as a whole. More specifically, as shown in FIG. 3, the insertion part 121, which is a rod-shaped end part, may be formed in a shape where the end part gradually narrows to facilitate insertion into the through hole. The rod handle part 122, which is the other end part, may be provided with a handle ring to facilitate gripping.

Further, in the insertion part 121 of the fixing means 120, a hooking operation device 121d that elastically hook-operates at the end part of the inserted through hole is elastically supported by an elastic spring 121c on the coupling sheet 121b, and may be installed in the insertion hole 121a of the insertion part 121.

The mounting member 200 includes a fixed head part 210 fixedly coupled to one of the fixing parts (110), and a guide tube part 220 that is integrally provided with the fixed head part 210. Herein, the fixing head part 210 and the guide tube part 220 may be mounted and connected by a mounting connecting part 230 formed in a plate shape along the longitudinal direction.

The fixing head part 210 is provided with a protruding head 211 that can ensure a coupling force with the tongs 112 provided on the fixing part 110. The protruding head 211 has both side surfaces protruding outward along the longitudinal direction, and may be formed at the upper end of the mounting connecting part 230 and configured in a “T” shape. And, the fixed head part 210 formed in this manner may have grooves formed at both end parts in the longitudinal direction, or may be formed in the form of a through hole along the entire longitudinal direction. Unlike the same, the head fixture 212 may be provided in the form of a protruding connecting rod at both end parts in the longitudinal direction, or in a connecting method corresponding to each other among the various coupling methods of the fixed connecting rod 213 that connects the end parts of the through hole or groove shape to each other.

The guide tube part 220 is configured such that a roller unit 310 of a sliding member 300, which will be described later, is slidable thereon. Preferably, the guide tube part 220 is configured such that the roller unit 310 slides along the outer circumferential surface of the guide tube part 220 in the longitudinal direction. To facilitate the sliding of the roller unit 310, a circular steel pipe with a diameter of 48.6 mm*thickness of 2.3 mm, which is commonly used as a scaffold pipe at construction sites, is used. However, the shape of the guide tube part 220 is not limited to a circular tube, and a polygonal pipe such as a triangular pipe or square pipe may be used as needed.

When the guide tube part 220 is formed as a circular tube, a part of the outer circumferential surface of the circular tube may be formed as a guide surface 223, which is a flat surface along the longitudinal direction. The roller unit 310 of the sliding member 300 adheres and slides (rolls) along the guide surface 223 formed in this way. However, since the rollers of the roller unit 310 come into contact with the flat horizontal surface of the guide surface 223 over a large area and slide (roll), the roller unit 310 can slide while having a constant directionality along the guide surface 223 without rotating in the circumferential direction of the circular tube, even if the guide tube part 220 is formed as a circular tube.

Further, the guide tube part 220 can be configured to directly connect to other adjacent guide tube parts 220 and the guide tube parts 220. In this case, the fixed head part 210 formed integrally with one guide tube part 220 is also configured to be directly connected to another fixed head part 210 formed integrally with the other guide tube part 220. Alternatively, if necessary, as shown in FIG. 1, the connecting tube part 410 of the connecting member 400 may be configured to connect one guide tube part 220 and the other guide tube part 220.

As mentioned above, in order to ensure that one guide tube part 220 is connected to another guide tube part 220 or to the connecting tube part 410 of the connecting member 400, connection sockets 221 may be formed at both ends in the longitudinal direction of the guide tube part 220.

The connecting socket 221 may be formed in the form of a groove at both end parts in the longitudinal direction of the guide tube part 220, or may be formed to penetrate through the guide tube part 220 in the longitudinal direction. Alternatively, the connecting socket 221 may be formed in the form of a protruding connecting rod at both end parts in the longitudinal direction, or in a corresponding connecting method among various connecting methods of the socket connecting rod 222 that connects the ends in the form of a through or groove shape.

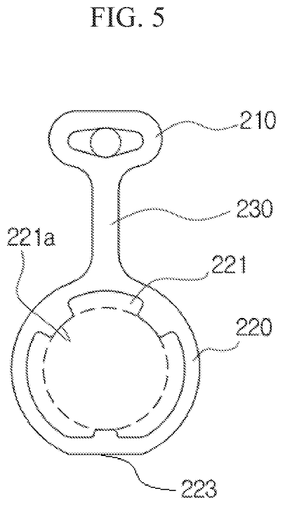

Preferably, as shown in FIG. 5, the connecting socket 221 may also be formed to further include a reinforcing rib 221a that can increase self-reinforcing force in at least two locations along the inner diameter while the inside penetrates by one.

Further, in the above, one mounting member 200 may be directly connected to the other mounting member 200, and in this case, the fixing head parts 210 may be connected to each other by the fixed connecting rod 213, and the guide tube part 220 may be connected to each other by the socket connecting rod 222. Due to such coupling characteristics, the mounting members 200 have a certain directionality, and even if an external force occurs, a coupling force with a constant directionality is maintained, which is advantageous in that stable sliding of the sliding member 300 sliding on the guide tube part 220 is ensured.

As shown in FIG. 1, when the mounting members 200 coupled to the fixing members 100 are arranged spaced apart from each other, the connecting member 400 is configured such that the mounting members 200 arranged spaced apart from each other are connected in a row, so that the sliding member 300 can move without interruption.

Therefore, at least among the configurations of the mounting member 200, the guide tube part 220 through which the sliding member 300 slides must be connected. In other words, the connecting member 400 is configured such that the guide tube parts 220 arranged spaced apart from each other are connected to each other. In order to ensure that the sliding member 300, which slides on the guide tube part 220, can continuously slide smoothly on the connecting member 400 connected to the guide tube part 220 without resistance, a connecting tube part 410 is provided into a shape corresponding to the guide tube part 220.

The connecting tube part 410 has a shape corresponding to the guide tube part 220 so that the sliding member 300, which has slide on the guide tube part 220, can continuously and smoothly allow transition and sliding without resistance. Accordingly, when the guide tube part 220 is formed as a circular tube, the connecting tube part 410 is also formed as the same circular tube as the guide tube part 220. In addition, when the guide tube part 220 is formed as a triangular or square polygonal tube, the connecting tube part 410 is also formed of a corresponding triangular or square polygonal tube.

Further, when the connecting tube part 410 is formed as a circular tube, this connecting tube part 410 is formed with a connecting surface 411 in a plane corresponding to the guide surface 223, which is a plane of the guide tube part 220. The connecting surface 411 is a flat surface in which a part of the outer circumferential surface of the connecting tube part 410 formed of a circular tube is formed to be flat along the longitudinal direction. The roller unit 310 of the sliding member 300 closely adheres and slides (rolls) along the connecting surface 411 formed in this way. However, since the rollers of the roller unit 310 contact and slide over a large area on the flat horizontal surface of the connecting surface 411, the roller unit 310 can slide with a constant directionality along the connecting surface 411 without rotating in the circumferential direction of the circular pipe, even if the connecting tube part 410 is formed as a circular tube.

In addition, the connecting head part 420 corresponding to the fixed head part 210 of the mounting member 200 may be connected to the connector part 410 by an intermediate connecting part 430.

Further, both longitudinal ends of the connecting tube part 410 and the connecting head part 420 may be provided with a connecting socket 412 and a connecting fixture 421 for the purpose of coupling the guide tube part 220 and the fixing head part 210, respectively. The connecting socket 412 and the connecting fixture 421 may be formed in the form of an insertion groove, a through hole, a protruding rod, or a connecting rod corresponding to the connecting socket 221 and the head fixture 212.

The connecting socket 412 is provided at both end parts in the longitudinal direction of the connecting tube part 410, and may be directly coupled and connected to the connecting socket 221 of the guide tube part 220, or may be connected and coupled via a socket connecting rod 222. In addition, the connecting fixture 421 is provided at both end parts in the longitudinal direction of the connection head part 420, and is directly coupled to the head fixture 212 of the fixed head part 210, or can be connected through via the fixed connecting rod 213.

In addition, the connecting tube part 410 and the connecting head part 420 are connected to the connecting member 400 by an intermediate connecting part 430 to form an integrated structure, and then can be connected to the guide tube part 220 and the fixed head part 210 of the mounting member 200 using the socket connecting rod 222 and the fixed connecting rod 213. In this case, since the fixed head part 210 and the connecting head part 420 are coupled and connected by the connecting fixture 421, and the guide tube part 220 and the connecting tube part 410 are coupled and connected by the socket connecting rod 222, the connecting member 400 can be connected to the mounting member 200 while maintaining a certain directionality, whereby there is an advantage that stable sliding of the sliding member 300 sliding on the guide tube part 220 is ensured.

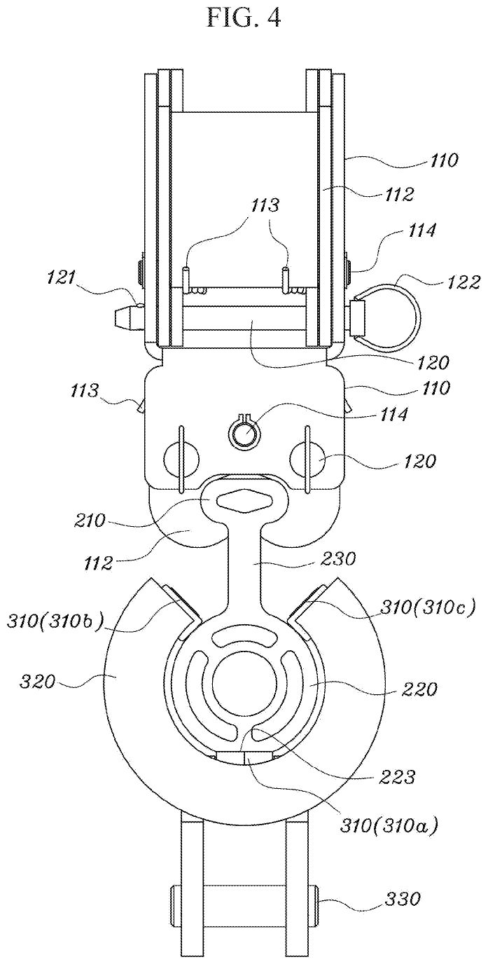

The sliding member 300 includes a roller unit 310 that slides the guide tube part 220 of the mounting member 200 and/or the connecting tube part 410 of the connecting member 400. The safety strap 4 may be provided on one side of the sliding member 300. Preferably, as shown in FIG. 4, it is detachably connected to the safety strap portion 330 provided at the lower part of the roller housing 320.

The roller housing 320 in which the roller unit 310 is installed may be formed to correspond to the shape of the guide tube part 220 and/or the connecting tube part 410. Preferably, a part of the circular ring is formed with an open opening corresponding to the guide tube part 220 and/or the connecting tube part 410, which are formed as circular pipes. As the opening is formed, interference with the connecting parts 230 and 240 of the mounting member 200 and/or the connecting member 400 does not occur.

In addition, the roller housing 320 is provided with a roller unit 310 that slides along the outer circumferential surface of the guide tube part 220 and/or the connecting tube part 410. Preferably, it is formed of first, second, and third roller units 310a, 310b and 310c in the shape of an equilateral triangle.

The first roller part 310a provided at the base of the equilateral triangle is configured to slide over a relatively large area relative to the guide surface 223 and/or the connecting surface 411, which are the planes of the guide tube part 220 and/or the connecting tube part 410. Through this, even if the guide tube part 220 and/or the connecting tube part 410 are formed as a circular pipe, the sliding member 300 can move in a straight line without rotating in the circumferential direction of the circular pipe due to the grounding of the large area of the first roller unit 310a and the guide surface 223 and/or the connecting surface 411.

And, a second roller unit 310b and a third roller unit 310c are provided on both equilateral sides of the equilateral triangle shape, respectively. The second and third roller parts 310b and 310c guide the stable sliding of the sliding member 300 by making linear (rolling) contact with the outer circumferential surface of the guide tube part 220 and/or the connecting tube part 410, which is a circular pipe.

In addition, a safety strap portion 330 may be provided at the lower part of the slide housing. The connection ring of the safety strap 4 connected to the body of the worker is movably coupled to the safety strap portion 330.

### DESCRIPTION OF REFERENCE NUMERALS

| | |
|---|---|
| 1: vertical pipe | 2: horizontal pipe |
| 3: joist pipe | 4: safety strap |
| 10: sliding apparatus | |
| 100: fixing member | |
| 110: fixing part | 111: tongs housing |
| 111a: recessed seating groove | 111b: support plate |
| 111c: opposing side wall | 111d: opposing through hole |
| 111e: shaft through hole | 112: tongs |
| 112a: claw | 112b: claw through hole |
| 112c: shaft hole | 113: torsion spring |
| 114: shaft rod | 120: fixing means |
| 121: insertion part | 121a: insertion hole |
| 121b: coupling sheet | 121c: elastic spring |
| 121d: hooking operation device | 122: rod handle portion |
| 200: mounting member | |
| 210: fixed head part | 211: protruding head |
| 212: head fixture | 213: fixed connecting rod |
| 220: guide tube part | 221: connecting socket |
| 222: socket connecting rod | 223: guide surface |
| 230: mounting connecting part | |
| 300: sliding member | |
| 310: roller unit | 320: roller housing |
| 330: safety strap portion | |
| 400: connecting member | |
| 410: connecting tube part | 411: Connecting surface |
| 412: connecting socket | 420: Connecting head part |
| 421: connecting fixture | 430: intermediate connecting portion |

1. A multipurpose sliding apparatus comprising:
a fixing member in which two fixing parts each having a tongs that detachably seat and couple an object to a recessed seating groove of a tongs housing are coupled in different directions, and which comprises a fixing means that maintains the coupling state of the object by the tongs and at the same time fixes the coupling position;
a mounting member in which a fixed head part integrally equipped with a guide tube part is fixedly coupled to one of the fixing parts; and
a sliding member provided with a roller part that slides along the guide tube part,
wherein the tongs housing is formed with an opposing through hole that passes in a straight line through a pair of opposing side walls in which the recessed seating groove is provided at the end extending in the vertical direction from the support plate; and a pair of claws axially opposing the shaft rod installed on the opposing side wall are installed so as to operate elastically by a torsion spring, whereby in the tongs, which couples and fixes an object by entering and seating it into the recessed seating groove, a claw through hole is formed through a pair of claws, and
wherein during the gripping operation of the tongs on an object, the rod-shaped fixing means that crosses the opposing through hole and the craw through hole arranged in a straight line are inserted and coupled to each other, so that the position between the fixing part and the object is fixed.

2. A multipurpose sliding apparatus comprising:
a fixing member in which two fixing parts each having a tongs that detachably seat and couple an object to a recessed seating groove of a tongs housing are coupled in different directions, and which comprises a fixing means that maintains a coupling state of the object by the tongs and at the same time fixes the coupling position;
a mounting member in which a fixed head part integrally equipped with a guide tube part is fixedly coupled to one of the fixing parts; and
a sliding member provided with a roller part that slides along the guide tube part,
wherein the guide tube part is a circular tube, the roller part slides along the longitudinal direction of the outer circumferential surface of the circular tube, and a part of the outer circumferential surface of the circular tube is formed as a guide surface, which is a flat surface along the longitudinal direction, thereby preventing circumferential rotation of the roller part sliding on the guide surface.

3. The multipurpose sliding apparatus as claimed in claim 1, wherein:
the mounting members are coupled to the fixing member and arranged spaced apart from each other,
the mounting members arranged spaced apart from each other are connected by a connecting member provided with a connecting tube part that connects at least the guide tube parts to each other, and
the sliding member slides along the guide tube part and the connecting tube part.

4. The multipurpose sliding apparatus as claimed in claim 2 wherein:
the mounting members are coupled to the fixing member and arranged spaced apart from each other,
the mounting members arranged spaced apart from each other are connected by a connecting member provided with a connecting tube part that connects at least the guide tube parts to each other, and
the sliding member slides along the guide tube part and the connecting tube part.

5. The multipurpose sliding apparatus as claimed in claim 3, wherein the mounting member comprises a configuration in which:
the fixing head part is hooked and fixed to the fixing part using protruding heads that protrude on both sides along the longitudinal direction, and
the roller part slides in the longitudinal direction of the outer circumferential surface of the guide tube part, which is connected to the fixed head part with the mounting connecting part, and at the same time, the connecting tube part of the connection member is coupled to the connection sockets provided at both ends of the guide tube part in the longitudinal direction.

6. The multipurpose sliding apparatus as claimed in claim 3, wherein:
the guide tube part and the connecting tube part are formed as circular pipes corresponding to each other, and the roller unit slides along the longitudinal direction of the outer circumferential surface of the circular pipe,
wherein a part of the outer circumferential surface of the circular pipe is a flat surface along the longitudinal direction and is formed into a guide surface and a connection surface, respectively, so that the roller part sliding on the guide surface and the connecting surface is prevented from rotating in the circumferential direction.

7. The multipurpose sliding apparatus as claimed in claim 4, wherein the mounting member comprises a configuration in which:
the fixing head part is hooked and fixed to the fixing part using protruding heads that protrude on both sides along the longitudinal direction, and
the roller part slides in the longitudinal direction of the outer circumferential surface of the guide tube part, which is connected to the fixed head part with the mounting connecting part, and at the same time, the connecting tube part of the connection member is coupled to the connection sockets provided at both ends of the guide tube part in the longitudinal direction.

8. The multipurpose sliding apparatus as claimed in claim 4, wherein:
the guide tube part and the connecting tube part are formed as circular pipes corresponding to each other, and the roller unit slides along the longitudinal direction of the outer circumferential surface of the circular pipe,
wherein a part of the outer circumferential surface of the circular pipe is a flat surface along the longitudinal direction and is formed into a guide surface and a connection surface, respectively, so that the roller part sliding on the guide surface and the connecting surface is prevented from rotating in the circumferential direction.

9. The multipurpose sliding apparatus as claimed in claim 5, wherein:
the connecting socket is formed to further include reinforcing ribs that penetrate through the inside and can increase self-reinforcing force in at least two locations along the inner diameter.

10. The multipurpose sliding apparatus as claimed in claim 6, wherein:
the connecting socket is formed to further include reinforcing ribs that penetrate through the inside and can increase self-reinforcing force in at least two locations along the inner diameter.
